(19) United States
(12) Patent Application Publication
(10) Pub. No.: US 2025/0275840 A1
(43) Pub. Date: Sep. 4, 2025

(54) 4D TOOTH MODELING SYSTEM AND METHOD FOR MODELING TEETH IN 4D VIA MOBILE DEVICE-BASED RGB VIDEO AND OPTICAL SENSING TECHNOLOGY

(71) Applicants: RuiSheng Zhao, San Jose, CA (US); Yunshi Xie, Reno, NV (US); Justin Zhao, Cupertino, CA (US); Anchao Li, London (GB); Jiyao Shang, San Jose, CA (US); Dongyang Yu, Beijing (CN); Yanwen Qin, San Jose, CA (US); Na Zhao, San Jose, CA (US); Wangpeng An, San Jose, CA (US); Haoyue Zhang, San Jose, CA (US); Yue Yu, Wuhan (CN); Mingya Zhang, Nanjing (CN)

(72) Inventors: RuiSheng Zhao, San Jose, CA (US); Yunshi Xie, Reno, NV (US); Justin Zhao, Cupertino, CA (US); Anchao Li, London (GB); Jiyao Shang, San Jose, CA (US); Dongyang Yu, Beijing (CN); Yanwen Qin, San Jose, CA (US); Na Zhao, San Jose, CA (US); Wangpeng An, San Jose, CA (US); Haoyue Zhang, San Jose, CA (US); Yue Yu, Wuhan (CN); Mingya Zhang, Nanjing (CN)

(21) Appl. No.: 18/593,614

(22) Filed: Mar. 1, 2024

(51) Int. Cl. A61C 13/34; A61B 1/24; A61C 9/00; G01S 17/86; G01S 17/89; G06T 17/00

(52) U.S. Cl. CPC A61C 13/34; A61C 9/0053; G06T 17/00; G01S 17/86; G01S 17/89; G06T 2200/24; G06T 2210/41

(57) ABSTRACT

A 4D tooth modeling system that utilizes mobile device-based RGB videos and optical sensing technology to determine depth of teeth and a method for modeling teeth in 4D via mobile device-based RGB video and optical sensing technology are disclosed. The 4D tooth modeling system leverages RGB videos and optical sensing technology, such as LiDAR depth sensors, on mobile devices to perform accurate and non-invasive dental scans by way of the method for modeling teeth in 4D via mobile device-based RGB video and optical sensing technology. The 4D tooth modeling system substantially enhances patient comfort, expedites the scanning process, and significantly reduces both equipment and maintenance costs, making the 4D tooth modeling system a highly accessible and convenient solution for dental practices.

### BACKGROUND

Embodiments of the invention described in this specification relate generally to dental imaging devices and systems, and more particularly, to a 4D tooth modeling system that utilizes mobile device-based RGB videos and optical sensing technology to determine depth of teeth and a method for modeling teeth in 4D via mobile device-based RGB video and optical sensing technology.

The state of dentistry is currently insufficient to accurately and efficiently create four-dimensional (“4D”) tooth models of patients. This has been a long-running problem in the dental industry for both patients and dentists. Specifically, traditional dental imaging methods, such as manual impressions and two-dimensional (“2D”) X-rays, can be uncomfortable for patients, time-consuming, and may not provide sufficient detail for complex dental treatments. Additionally, existing dental scanning technologies may require bulky or expensive equipment and might not adequately capture the full morphology of teeth.

For instance, there are several existing devices and systems in the field of dental imaging which are available to do scanning and teeth impressions. However, the existing devices and systems typically involve problematic aspects such as requiring invasive manual impressions or requiring 2D X-rays that are cumbersome to acquire and bothersome to most patients. Obtaining the manual impressions and 2D X-rays also tends to require expensive and specialized scanning equipment. Overall, the state of art in technology and practices in the dental industry often straddles dental practices with high costs, yet still resulting in time-consuming procedures that often leads to discomfort for patients.

Therefore, what is needed is an innovative, user-friendly, and cost-effective way to obtain precise and detailed 4D tooth models to enhance the overall dental care experience and facilitate a wider range of successful dental treatments.

### BRIEF DESCRIPTION

A novel 4D tooth modeling system that utilizes mobile device-based RGB videos and optical sensing technology to determine depth of teeth and a novel method for modeling teeth in 4D via mobile device-based RGB video and optical sensing technology are disclosed. In some embodiments, the 4D tooth modeling system leverages RGB videos and optical sensing technology, such as LiDAR depth sensors, on mobile devices to perform accurate and non-invasive dental scans by way of the method for modeling teeth in 4D via mobile device-based RGB video and optical sensing technology. In some embodiments, the 4D tooth modeling system substantially enhances patient comfort, expedites the scanning process, and significantly reduces both equipment and maintenance costs, making the 4D tooth modeling system a highly accessible and convenient solution for dental practices.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a block diagram of several components of a 4D tooth modeling system in some embodiments and functional effects of the components in performing the method for modeling teeth in 4D via mobile device-based RGB video and optical sensing technology.

FIG. 2 conceptually illustrates a block diagram of the mobile application and several additional components of the 4D tooth modeling system in some embodiments and functional effects of the components in performing the method for modeling teeth in 4D via mobile device-based RGB video and optical sensing technology.

FIG. 3 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Embodiments of the invention described in this specification include a 4D tooth modeling system that utilizes mobile device-based RGB videos and optical sensing technology to determine depth of teeth and a method for modeling teeth in 4D via mobile device-based RGB video and optical sensing technology. In some embodiments, the 4D tooth modeling system leverages RGB videos and optical sensing technology, such as LiDAR depth sensors, on mobile devices to perform accurate and non-invasive dental scans by way of the method for modeling teeth in 4D via mobile device-based RGB video and optical sensing technology. In some embodiments, the 4D tooth modeling system substantially enhances patient comfort, expedites the scanning process, and significantly reduces both equipment and maintenance costs, making the 4D tooth modeling system a highly accessible and convenient solution for dental practices.

As stated above, the state of dentistry is currently insufficient to accurately and efficiently create 4D tooth models of patients. This has been a long-running problem in the dental industry for both patients and dentists. Specifically, traditional dental imaging methods, such as manual impressions and 2D X-rays, can be uncomfortable for patients, time-consuming, and may not provide sufficient detail for complex dental treatments. Additionally, existing dental scanning technologies may require bulky or expensive equipment and might not adequately capture the full morphology of teeth. For instance, there are several existing devices and systems in the field of dental imaging which are available to do scanning and teeth impressions. However, the existing devices and systems typically involve problematic aspects such as requiring invasive manual impressions or requiring 2D X-rays that are cumbersome to acquire and bothersome to most patients. Obtaining the manual impressions and 2D X-rays also tends to require expensive and specialized scanning equipment. Overall, the state of art in technology and practices in the dental industry often straddles dental practices with high costs, yet still resulting in time-consuming procedures that often leads to discomfort for patients. This problem highlights the need for an innovative, user-friendly, and cost-effective solution to obtain precise and detailed 4D tooth models to enhance the overall dental care experience and facilitate a wider range of successful dental treatments. Embodiments of the 4D tooth modeling system described in this specification solve such problems by utilizing RGB videos and LiDAR depth data from readily available mobile devices to create accurate and precise tooth models in real-time. This approach eliminates the need for traditional manual impressions, 2D X-rays, or bulky scanning equipment, and provides a comfortable, efficient, and cost-effective solution for patients and dental professionals. By harnessing the advanced imaging capabilities of mobile devices, the system captures the full morphology of teeth and generates high-quality 4D models, enabling improved dental treatment planning and execution, and enhanced patient experiences.

Embodiments of the 4D tooth modeling system described in this specification differ from and improve upon currently existing options. In particular, the devices and systems fall short in delivering optimal patient experiences because they often require uncomfortable and invasive procedures, lengthy appointment times, and generate additional financial burdens due to specialized equipment and technical maintenance, ultimately limiting their accessibility and convenience. By contrast, the 4D tooth modeling system described in this disclosure stands out in its field by leveraging the ubiquity of mobile devices equipped with RGB videos and LiDAR depth sensors, transforming them into convenient and powerful dental scanning tools. In this regard, the 4D tooth modeling system innovatively offers a more accessible, cost-effective, and patient-friendly solution, compared to traditional and existing dental imaging methods, while maintaining high accuracy and precision in generating 4D tooth models. Specifically, the 4D tooth modeling system leverages RGB videos and LiDAR depth sensors on mobile devices to perform accurate and non-invasive dental scans, substantially enhancing patient comfort, expediting the scanning process, and significantly reducing both equipment and maintenance costs, making it a highly accessible and convenient solution for dental practices.

The 4D tooth modeling system of the present disclosure may be comprised of the following elements. This list of possible constituent elements is intended to be exemplary only and it is not intended that this list be used to limit the 4D tooth modeling system of the present application to just these elements. Persons having ordinary skill in the art relevant to the present disclosure may understand there to be equivalent elements that may be substituted within the present disclosure without changing the essential function or operation of the 4D tooth modeling system.
1. Mobile device with an RGB camera and LiDAR depth sensor: The core component for capturing high-resolution RGB videos and accurate depth information of the dental subjects.
2. 4D Tooth Modeling software: A proprietary software solution that processes and merges the RGB video and LiDAR depth data to create an accurate and detailed 4D digital representation of the teeth.
3. Mobile device application: A user-friendly interface enabling dental professionals to control the scanning process, manage patient information, and visualize the generated 4D tooth models.
4. Dental retractor: A simple and comfortable dental appliance used to help patients keep their mouth open and expose their teeth adequately for the scanning process.
5. Calibration tool: A physical or virtual component designed to calibrate the mobile device's camera and the LiDAR depth sensor, ensuring optimal alignment and data accuracy during the scans.
6. Cloud storage and processing option: A secure platform for storing, analyzing, sharing, and processing the 4D tooth models, providing real-time collaboration between dental professionals and fostering more efficient patient management.

The 4D tooth modeling system of the present disclosure generally works to create an accurate and detailed digital representation of a patient's teeth. Individually, each component has a specific purpose:
1. The mobile device with an RGB camera and LiDAR depth sensor (Item 1) captures high-resolution color images and precise depth information for creating an accurate 3D representation of the dental structure.
2. The 4D Tooth Modeling software (Item 2) processes the captured data, interpolating and fusing the image and depth information to generate complete and well-defined 4D digital tooth models.
3. The mobile device application (Item 3) allows the dental professional to control and manage the scanning process, while also serving as an interface for visualizing and handling the generated tooth models.
4. The dental retractor (Item 4) ensures proper mouth opening and exposure of dental surfaces during scanning, enabling the mobile device (Item 1) to acquire as much information as possible for an accurate model.
5. The calibration tool (Item 5) optimizes the alignment and accuracy of the RGB camera and LiDAR depth sensor (Item 1), which is crucial for obtaining consistent and reliable data for the modeling process.
6. The cloud storage and processing option (Item 6) enables storage, sharing, and processing of the 4D tooth models, providing a secure and efficient platform for collaboration and patient management.

When these components work together, the system can perform its desired function effectively:
1. The dental professional uses the mobile device application (Item 3) to initiate the scanning process, which involves capturing images and depth data with the mobile device's RGB camera and LiDAR depth sensor (Item 1).
2. The patient's mouth is kept open with the dental retractor (Item 4), ensuring that all dental surfaces are adequately exposed and captured during the scan.
3. The calibration tool (Item 5) maintains proper alignment and accuracy of the mobile device (Item 1) throughout the scanning process.
4. The captured data is processed by the 4D Tooth Modeling software (Item 2) to create an accurate 4D digital model of the patient's teeth.
5. The dental professional can visualize, review, and analyze the generated tooth models via the mobile device application (Item 3).
6. Finally, the 4D tooth models can be stored, accessed, and processed on the cloud storage platform (Item 6), enabling efficient collaboration and treatment planning between dental professionals.

The combined efforts of all these components ultimately allow dental professionals to create highly detailed and accurate 4D tooth models, leading to more effective diagnosis and treatment planning for their patients.

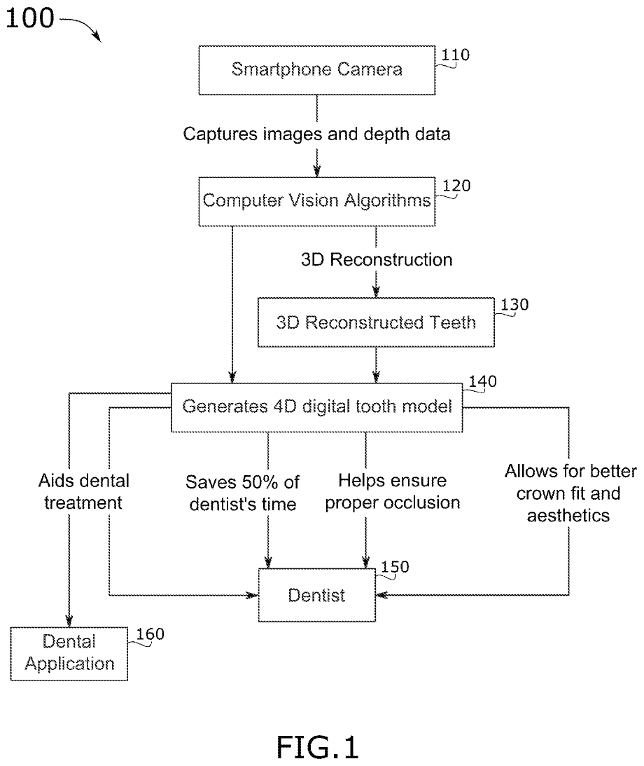

By way of example, FIG. 1 conceptually illustrates a block diagram of several components of a 4D tooth modeling system 100 and functional effects of the components in performing the method for modeling teeth in 4D via mobile device-based RGB video and optical sensing technology. As shown in this figure, the 4D tooth modeling system 100 includes a smartphone camera 110, computer vision algorithm(s) 120, a 3D reconstructed tooth model 130, a 4D digital tooth model 140, and dental application 160. Also, a dentist 150 is a user of the 4D tooth modeling system 100.

The smartphone camera 110 is triggered to capture imagery (images and/or videos) and depth data. This is done via the onboard camera of the smartphone operated by the dentist 150 and a LiDAR sensor connected to or embedded as a component of the smartphone camera 110. After capturing the imagery and depth data, the computer vision algorithm(s) 120 of the 4D tooth modeling system 100 process the image/depth data in order to perform 3D reconstruction from 2D imagery/video and the corresponding LiDAR captured depth data. The result is a 3D reconstructed tooth model 130 which is then reprocessed by the computer vision algorithm(s) 120 (in combination with time-spaced video imagery) to generate a 4D digital tooth model 140. The generated 4D digital tooth model 140 is automatically available for the dental application 160 (mobile app) or transferred to the dental application 160 (mobile app) in order to aid in the dental treatment of the patient. Furthermore, the dentist can view the resultant 4D digital tooth model 140. This has the potential to save the dentist a lot of time (e.g., 50% of time is saved through this process), and helps the dentist 150 to ensure proper occlusion and allows for better crown fitting and other aesthetics.

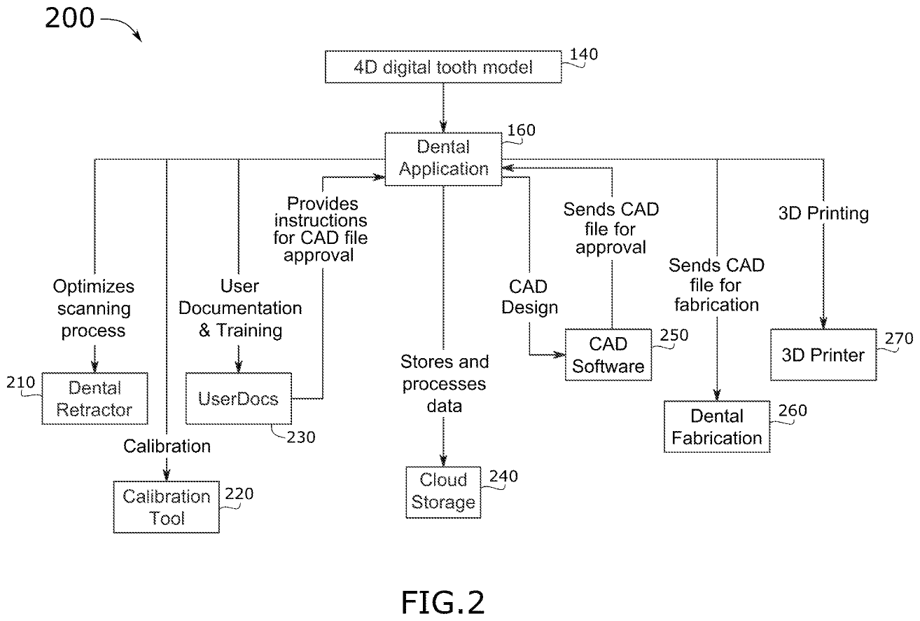

Now, turning to another view, FIG. 2 conceptually illustrates a block diagram of the dental mobile application with the 4D digital tooth model already generated 400. As shown in this figure, the dental application 160 (which is mobile application running on the smartphone) has received the 4D digital tooth model 140 as generated by the computer vision algorithm(s) of the 4D tooth modeling application. To optimize the scanning process, however, an optional item the dentist 150 may employ would be the dental retractor 210. Also, the calibration tool 220 is provided to ensure proper calibration of the results of the scan and image capture. The application 160 of some embodiments also provides user documents 230, such as user documentation and training resources, which provides instructions for computer aided design (“CAD”) file approval, which in some embodiments is needed before the dental application 160 accepts the generated 4D digital tooth model 140.

In some embodiments, the dental application 160 provides the CAD design file to CAD software 250 (which may be operated on the smartphone or on another computing device). The CAD software 250 processes the CAD file and then sends the CAD file back to the dental application 160 for approval, for example, by the dentist or automatically in the software. After approval, the dental application 160 sends the CAD file out to a fabricator for dental fabrication 260 and/or to a 3D printer for 3D printing of the model.

To make the 4D tooth modeling system of the present disclosure, a person would need to follow these steps:
1. Hardware selection and integration steps—first, choose a compatible mobile device with a built-in high-resolution RGB camera and LiDAR depth sensor that can capture detailed image and depth data. Choosing a mobile device with a high-resolution RGB camera and LiDAR depth sensor is essential since this combination is used for capturing the detailed images and depth information required for accurate 3D representations of dental structures. After choosing the mobile device with RGB camera and LiDAR depth sensor, obtain a dental retractor to help the patient keep their mouth open during the scanning process. Finally, acquire a calibration tool to ensure proper alignment and accuracy of the mobile device's RGB camera and LiDAR depth sensor.
2. Software development steps—start by developing the 4D tooth modeling software that will process the captured image(s) and depth data, as well as fuse them together to create highly detailed and accurate 4D digital tooth models. After developing the core 4D tooth modeling software, create a user-friendly mobile device application (or “mobile app”) that will serve as an interface for dental professionals to control the scanning process, access the 4D tooth modeling software, and visualize the generated 4D tooth models. Finally, integrate cloud storage and processing capabilities within the mobile app to allow for efficient storage, retrieval, and collaboration on the 4D tooth models.
3. System calibration and testing steps—these steps start with setting up and calibrating the mobile device with a calibration tool to ensure proper alignment and accuracy of the RGB camera and LiDAR depth sensor for data acquisition. Then test the system by capturing dental images and depth data using the mobile device's RGB camera and LiDAR depth sensor while a patient wears the dental retractor. Finally, validate the resulting 4D digital tooth models generated by the 4D tooth modeling software for accuracy and quality in comparison to the actual dental structure.

As noted above, the combination of the mobile device with a high-resolution RGB camera and LiDAR depth sensor is key for capturing the detailed images and depth information required for accurate 3D representations of dental structures. Furthermore, the 4D tooth modeling software is a core component for runtime processing of the captured data and for generating the 4D digital tooth models based on the captured data. The mobile app, when running on the mobile device, allows dental professionals to control, manage, and visualize the scanning process and generated tooth models. However, instead of a mobile app running on a mobile device, the software could be developed as conventional software that is configured to run on a personal computer (“PC”), a laptop computer, or another type of computing device.

Other components are also supported by the 4D tooth modeling system. Specifically, the calibration tool is included with the 4D tooth modeling system to ensure proper alignment and accuracy of the RGB camera and LiDAR depth sensor for consistent data acquisition. In some embodiments, user documentation and training are part of the 4D tooth modeling system. When deployed, the 4D tooth modeling system provides access to the user documentation and training as instructional materials and training opportunities is essential for proper usage and adoption of the system by dental professionals.

Although not required, the dental retractor helps to optimize the scanning process by ensuring proper mouth opening and dental surface exposure. Also, cloud storage and processing are not required for every deployment of the 4D tooth modeling system. However, cloud storage and cloud-based processing are useful for efficient data storage, collaboration, and patient management. In some embodiments, the 4D tooth modeling system integrates machine learning algorithms in an artificial intelligence (“AI”) sub-system of the 4D tooth modeling system. The machine learning algorithms of the AI sub-system are included to improve the accuracy and efficiency of the software in generating the 4D digital tooth models. In some embodiments, the 4D tooth modeling system integrates advanced visualization tools. The advanced visualization tools offer significant improvements in visualizing and analyzing the tooth models in the mobile app and may enhance the user experience or offer additional insights for dental professionals. The 4D tooth modeling system of some embodiments also enhances mobile device hardware integration. By working with mobile device manufacturers to optimize the integration of the RGB camera and the LiDAR depth sensor, the 4D tooth modeling system could lead to further improvements in data acquisition and overall system performance.

To use the 4D tooth modeling system of the present disclosure, a dental professional would use the 4D tooth modeling system to create highly accurate digital representations of a patient's dental structures for improved diagnosis, treatment planning, and patient education. The steps involved in using the 4D tooth modeling system comprise (i) patient preparation, (ii) device calibration, (iii) scanning process, (iv) data processing, (v) visualization and analysis, (vi) treatment planning, and (vii) data storage and collaboration. By following these steps, the dental professional can effectively leverage the 4D tooth modeling system to provide a higher standard of care, make more informed treatment decisions, and improve patient understanding and involvement in their dental care. Each of these steps are described in further detail below.

Patient preparation: The dental professional asks the patient to sit in the dental chair and positions their head in a stable and comfortable position. If using a dental retractor, the retractor is placed in the patient's mouth to ensure proper mouth opening and dental surface exposure.

Device calibration: The dental professional utilizes the calibration tool to calibrate the mobile device's high-resolution RGB camera and LiDAR depth sensor, ensuring proper alignment and accuracy during data acquisition.

Scanning process: The dental professional opens the mobile device application and starts the scanning procedure. They then systematically move the mobile device around the patient's mouth, capturing dental images and depth data using the integrated high-resolution RGB camera and LiDAR depth sensor.

Data processing: As the dental professional captures the dental images and depth data, the 4D tooth modeling software processes this information and generates a highly detailed and accurate 4D digital tooth model in real-time.

Visualization and analysis: The dental professional uses the mobile device application to visualize and analyze the generated 4D tooth model, reviewing the model for any abnormalities, misalignments, or other issues of concern.

Treatment planning: Based on the findings from the 4D tooth model, the dental professional can create a tailored treatment plan for the patient, taking into account the patient's unique dental structure and any identified issues.

Data storage and collaboration: if and when the 4D tooth modeling system includes cloud storage and processing capabilities, the dental professional can save the 4D tooth model to the cloud, facilitating easy retrieval, collaboration with other dental professionals if needed, and tracking of the patient's dental progress over time.

Additionally, the 4D tooth modeling system can be modified or adapted (as a “4D modeling system”) for use in various other fields and applications including, without limitation, orthopedics, dermatology, cultural heritage preservation, quality control in manufacturing, product design and prototyping, and others.

Specifically, in the field of orthopedics, the 4D modeling system can be adapted for use in generating 4D models of bones and joints to help orthopedic specialists diagnose conditions, monitor healing progress, and plan surgical interventions. To carry this modification out, the underlying technology of capturing high-resolution RGB images and depth data with a mobile device, processing the data, and generating detailed 4D models can be repurposed for visualizing bone structures and joint alignment.

In the field of dermatology, the 4D modeling system could be modified to focus on skin structures. In this way, dermatologists could use the dermatology-modified 4D modeling system technology to create 4D models of skin conditions for better examination, diagnosis, and treatment planning. This could be particularly useful for monitoring skin lesions, burns, and wound healing, as well as for evaluating the effectiveness of skincare treatments and cosmetic procedures.

For cultural heritage preservation, the technology of the 4D modeling system could be adapted in ways that are suitable for non-medical purposes. For instance, professionals in the field of art restoration and cultural heritage preservation could utilize the system in order to create highly accurate 4D models of objects, artifacts, and surfaces. The generated models can then be used to analyze, monitor, and document the condition of the objects, facilitating restoration and conservation processes. They could also be used in archival storage systems for inventory and other purposes.

With respect to quality control in manufacturing, the 4D modeling system could be adapted in a way that enables manufactured parts, assemblies, components, or products to be analyzed for flaws, defects, and deviations from design specifications. Manufacturers can use this technology to ensure the quality and conformity of their products while identifying any potential areas of improvement in their production processes.

For product design and prototyping, designers would be able to leverage the 4D modeling system to capture detailed digital models of physical prototypes, facilitating the evaluation and iterative improvement of product design.

While the preferred embodiment of the 4D modeling system is the 4D tooth modeling system applicable to the dental field, the 4D modeling system can potentially be expanded to produce various products, devices, compositions, and other useful items across different applications and industries. Examples of the types of things which the 4D modeling system may produce include, without limitation, dental 4D tooth models (as intended in the preferred embodiment), orthopedic 4D bone/joint models, dermatological 4D skin models, 4D models for cultural heritage preservation, quality control 4D models for manufacturing and products, product design and prototyping 4D models, and customized 4D prosthetics and implants. Each of these potential items that could be created by the 4D modeling system are described in further detail below.

Dental 4D tooth model(s): This is the original purpose of the invention, where the 4D tooth modeling system creates a detailed, colored, and time-based digital model of a patient's dental structures to aid in diagnosis, treatment planning, and patient education.

Orthopedic 4D bone/joint models: Adapted for orthopedics, the 4D modeling system can produce 4D models of bones and joints, allowing medical professionals to examine, diagnose, and plan for treatments, surgeries, and monitor healing progress.

Dermatological 4D skin models: Adapting the 4D modeling system for dermatology can result in the creation of 4D models of skin conditions, abnormalities and wounds, facilitating better examination, diagnosis, and treatment of various skin problems.

4D models for cultural heritage preservation: In the field of cultural heritage preservation and art restoration, the 4D modeling system can produce accurate 4D models of artifacts, sculptures, and surfaces to aid conservators and curators in their essential work.

Quality control 4D models for manufacturing and products: By generating detailed 4D models of manufactured components, parts, or products, the 4D modeling system can support quality control efforts and the identification of any areas of improvement in the manufacturing process.

Product design and prototyping 4D models: Applying the technology of the 4D modeling system to product design and prototyping can result in the generation of 4D models for evaluating, testing, and refining product designs before mass production.

Customized 4D prosthetics and implants: The 4D modeling system can also be utilized in creating 4D models of prosthetic devices, dental restorations, or orthopedic implants, allowing for better design and fit of these life-enhancing medical items.

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. For instance, the computer vision algorithms and the 3D tooth reconstruction and 4D digital tooth model generation software modules may be embedded into the 4D tooth modeling software, which itself may be incorporated into the mobile app which may include a user interface (“UI”). In some embodiments, multiple software inventions can also be implemented as separate programs. For example, the 4D tooth modeling software may be implemented as a separate program that operates independently of the mobile app. Finally, any combination of separate programs that together implement a software invention described here is within the scope of the invention. In some embodiments, the software programs, when installed to operate on one or more electronic systems, define one or more specific machine implementations that execute and perform the operations of the software programs.

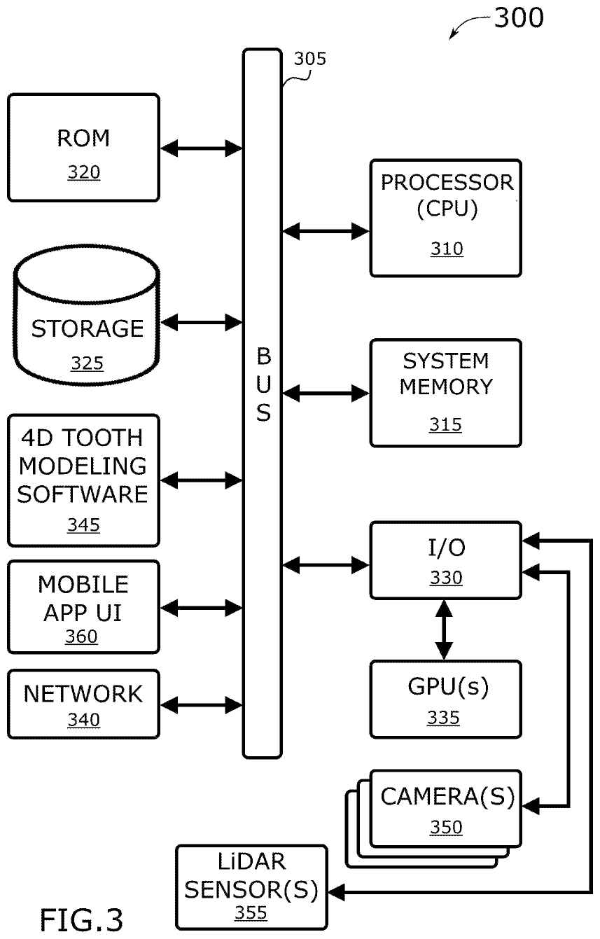

By way of example, FIG. 3 conceptually illustrates an electronic system 300 with which some embodiments of the invention are implemented. The electronic system 300 may be a computer, such as a smartphone mobile device of the dentist as described above, a tablet computing device, or any other sort of electronic device capable of capturing images and video (“imagery”), processing the imagery, determining depth via LiDAR sensor, and otherwise carrying out the software-implemented operations (steps) of the 4D tooth modeling method for modeling teeth in 4D. Such an electronic system includes various types of computer readable media and interfaces for various other types of computer readable media. Electronic system 300 includes a main system bus 305, a central processing unit (CPU) 310, a system memory 315, a read-only memory (ROM) 320, a permanent storage device 325, input/output (I/O) interface 330, graphics processing unit(s) (GPUs) 335 that connects to the main system bus 305 through a PCIe bus connecting through the I/O interface 330, and a network 340. Furthermore, electronic system 300 may connect to one or more external and/or specialized camera(s) 350 and one or more LiDAR sensor(s) 355 (for instance, mounted to an external camera) via the I/O interface 330. However, the camera(s) 350 and the LiDAR sensor(s) are onboard components of the electronic system 300 in some embodiments. Additionally, 4D tooth modeling software 345 is installed on the electronic system 300. Embedded in the 4D tooth modeling software 345 are software code implementations of the computer vision algorithm(s), as well as the 3D tooth reconstruction and 4D digital tooth model generation software modules. While the 4D tooth modeling software 345 may be stored in the permanent storage device 325, it is shown here for exemplary purposes.

The main system bus 305 collectively represents all system, peripheral, and chipset buses that communicatively connect the numerous internal devices of the electronic system 300, accept for a PCIe bus connected in support of GPUs 335. Besides the GPUs 335, the main system bus 305 communicatively connects the CPU 310 with the ROM 320, the system memory 315, and the permanent storage device 325.

From these various memory units, the CPU 310 retrieves instructions to execute and data to process in order to execute the processes of the invention. For instance, collecting 2D and 3D imagery/videos captured by the camera(s) 350 and determining depth measurements by the LiDAR sensor(s) 355 via the I/O interface 330. Furthermore, the CPU 310 may be a single processor or a multi-core processor in different embodiments.

The read-only-memory (ROM) 320 stores static data and instructions that are needed by the CPU 310 and other modules of the electronic system 300. The permanent storage device 325, on the other hand, is a read-and-write memory device. The permanent storage device 325 is a non-volatile memory unit that stores instructions and data even when the electronic system 300 is off. Some embodiments of the invention use a mass-storage device (such as a magnetic or optical disk and its corresponding disk drive) as the permanent storage device 325. Still other embodiments of the invention use a cloud storage system, accessible via network 340 (such as through a WiFi network adapter, a cellular network adapter, etc.) connection over the Internet, as the permanent storage device 325.

Other embodiments use a removable storage device (such as a floppy disk or a flash drive) as the permanent storage device 725. Like the permanent storage device 725, the system memory 715 is a read-and-write memory device. However, unlike storage device 725, the system memory 715 is a volatile read-and-write memory, such as a random access memory. The system memory 715 stores some of the instructions and image data that the CPU 710 needs at runtime. In some embodiments, the software implemented code for the 4D tooth modeling software 345 and the mobile app and UI 360 are stored in the system memory 315, the permanent storage device 325, and/or the ROM 320. From these various memory units, the CPU 310 retrieves instructions to execute, transmits instructions and imagery (2D/3D images/video clips) and other meta-data or other computer vision image processing data to the GPUs 335 for massively parallel processing which results in efficient real-time generation of the 4D tooth models.

The main system bus 305 also connects to the input/output interface 330, which itself connects to one or more camera(s) 350 (either onboard mobile device camera or an externally connected camera) and LiDAR sensor(s) 355. The camera(s) may include 2D digital cameras capable of capturing imagery and videos in a color space, such as Red-Blue-Green (“RGB”), and/or 3D cameras, etc. The LiDAR sensor(s) 355 may include laser scanners, spatial depth cameras, or other light detecting sensor devices that are capable of calculating depth measurements. The I/O interface 330 provides the input/output pathway for all image/video data that starts the process for generating 4D tooth models. However, it is noted here that other input devices may connect to the I/O interface 330 including alphanumeric keyboards and pointing devices (also called “cursor control devices”). Furthermore, other output devices may connect to the electronic system 300 via the I/O interface 330 including devices configured to display 2D and/or 3D images/videos and/or models. Examples of such other output devices include conventional printers, 3D printers, and display devices, such as liquid crystal displays (LCD) and organic light emitting diode (OLED) displays. Some embodiments include devices such as a touchscreen that functions as both input and output devices.

Finally, as shown in FIG. 3, bus 305 also couples electronic system 300 to the network 340 through a network adapter (not shown). In this manner, the computer can be a part of a network of computers (such as a local area network (“LAN”), a wide area network (“WAN”), or an intranet), or a network of networks (such as the Internet). Any or all components of electronic system 300 may be used in conjunction with the invention.

These functions described above can be implemented in digital electronic circuitry, in computer software, firmware or hardware. The techniques can be implemented using one or more computer program products. Programmable processors and computers can be packaged or included in other computing device forms, such as single board computers or mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

I claim:

1. A 4D tooth modeling system comprising:
a mobile device comprising a camera and a depth sensor used to determine information about a dental subject's teeth;
a 4D tooth modeling software application that is configured to process the information about the dental subject's teeth to create a 4D digital representation of the teeth of the dental subject; and
a mobile application that runs on the mobile device and is configured to visually output a user interface (UI).

2. The 4D tooth modeling system of claim 1, wherein the camera comprises an RGB camera.

3. The 4D tooth modeling system of claim 2, wherein the RGB camera is configured to capture a high-resolution RGB video of the teeth of the dental subject.

4. The 4D tooth modeling system of claim 3, wherein the depth sensor comprises a LiDAR sensor.

5. The 4D tooth modeling system of claim 4, wherein the LiDAR sensor is configured to capture LiDAR depth data of the teeth of the dental subject.

6. The 4D tooth modeling system of claim 5, wherein the 4D tooth modeling software application is further configured to merge the high-resolution RGB video and the LiDAR depth data to create the 4D digital representation of the teeth of the dental subject.

7. The 4D tooth modeling system of claim 1, wherein the UI of the mobile application comprises a plurality of interface tools accessible to a dentist operating the mobile device.

8. The 4D tooth modeling system of claim 7, wherein at least one of the interface tools accessible to the dentist through the UI of the mobile application is configured to control dental scanning of the teeth of the dental subject.

9. The 4D tooth modeling system of claim 8 further comprising a dental retractor used to help the dental subject maintain an open mouth to expose the teeth of the dental subject during dental scanning.

10. The 4D tooth modeling system of claim 8 further comprising a calibration tool that is configured to calibrate the camera and the depth sensor to ensure optimal alignment and data accuracy during dental scanning.

11. The 4D tooth modeling system of claim 7, wherein at least one of the interface tools accessible to the dentist through the UI of the mobile application is configured to manage patient information associated with the dental subject.

12. The 4D tooth modeling system of claim 7, wherein at least one of the interface tools accessible to the dentist through the UI of the mobile application is configured to visually output a 4D tooth model generated for the dental subject.

13. The 4D tooth modeling system of claim 1, wherein the 4D tooth modeling software application comprises code implementing a computer vision algorithm.

14. The 4D tooth modeling system of claim 13, wherein the 4D tooth modeling software application comprises code implementing a 3D tooth reconstruction algorithm.

15. The 4D tooth modeling system of claim 14 further comprising a cloud storage configured to store 4D tooth models generated by the 4D tooth modeling software application.
